(19) United States
(12) Patent Application Publication
(10) Pub. No.: US 2008/0134782 A1
(43) Pub. Date: Jun. 12, 2008

(54) Multifunctional Upfront Sensor

(75) Inventors: Alfred Kuttenberger, Hewanbey (DE); Matthias Wellhoefer, Stuttgart (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 11/547,047

(22) PCT Filed: Feb. 21, 2005
(86) PCT No.: PCT/EP2005/050745

§ 371 Date: Sep. 14, 2007

(30) Foreign Application Priority Data
Apr. 2, 2004 (DE) 10 2004 016 266.2

(51) Int. Cl. G01P 15/02; G01S 13/88

(52) U.S. Cl. 73/514.01; 342/118

(57) ABSTRACT

In order to provide a compact, multifunctional sensor element, a sensor element for acquiring the acceleration of a motor vehicle is additionally equipped with a distance measurement device for measuring the distance between the motor vehicle and a foreign object.

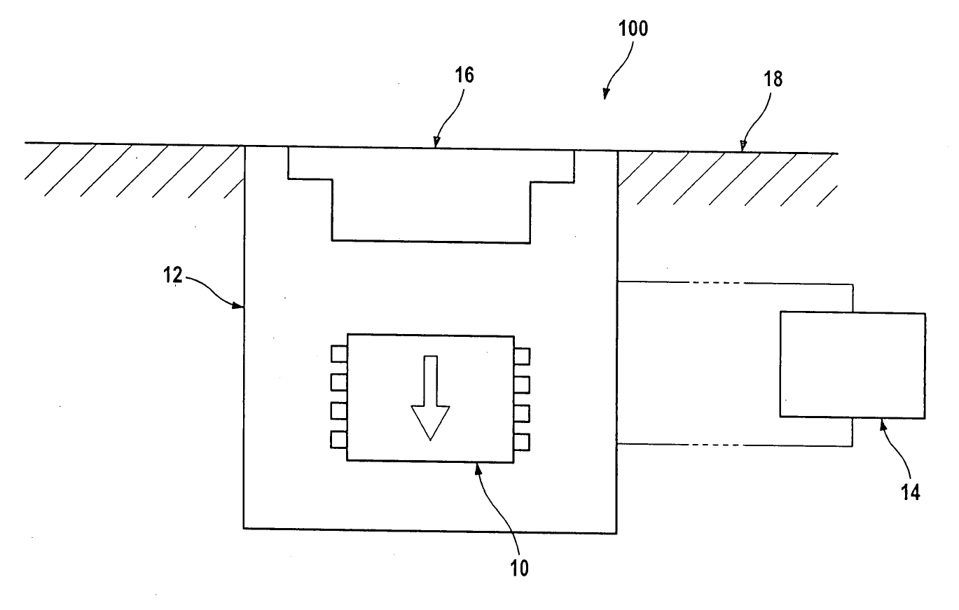

### FIELD OF THE INVENTION

The present invention relates to a sensor element for acquiring the acceleration of a vehicle.

### BACKGROUND INFORMATION

It is known to position acceleration sensors (called upfront sensors) in the front area of a motor vehicle in order to supply information about the severity of an accident at an early stage of the accident. This technology is intended to calculate various accident scenarios and to correspondingly activate various restraint systems, such as air bags or safety belts. In particular, the control device of the vehicle should be able to distinguish critical collisions from cases in which it is not necessary to trigger the restraint means. For example, the control device can use the data supplied by the upfront sensor to calculate precisely, at an early point in time, whether it is necessary to trigger an airbag.

The basic principle of all sensors for measuring an acceleration is to detect the action of the acceleration on a damped spring-mass system, called a seismic mass. The acceleration causes the seismic mass, which is coupled elastically to the housing, to be displaced. The task of the sensors is to evaluate the degree of acceleration-caused deflection using piezoresistive, capacitive, or frequency-analog systems.

In the case of acceleration sensors attached to a vehicle, the displacement of the seismic mass is most often measured through changes in capacitances. Here, the seismic mass is formed as an electrode of one or more capacitors, this system preferably being constructed as a differential capacitor, so that the plate spacing of the one capacitor is reduced by the same amount by which that of the other is increased. The measurement voltage in the system is here proportional to the mass displacement.

The capacitors are formed as upfront sensors in the form of a micromechanical comb structure attached to the surface of a silicon wafer.

There is a trend towards positioning of the acceleration sensors increasingly further forward on the vehicle housing. Upfront sensors are already being tested at positions in the crumple zone of the vehicle, directly behind the outer panel or on the bumper rail.

Moreover, various types of sensors are known for measuring the distance between the vehicle and a foreign object, which are used predominantly for comfort and safety functions. Such sensors are based on sonar methods.

Thus, ultrasound distance sensors are known in which an evaluation unit sends out a pulse signal and the time is measured until the arrival of an echo signal. Another pulse is then sent out. The sound signals that impinge on an object are reflected and are received by a sound receiver of the distance measurement device. Via a computing unit that controls the sound source and the sound receiver, the received sound signals are identified, the propagation time of the sound signals is calculated, and from these data the distance of the object reflecting the sound signals is determined. Such distance measurement devices are used for example in distance warning systems used as parking aids in motor vehicles. Such parking aids using ultrasonic sensors typically monitor a range of about 30 cm to 150 cm behind or in front of the vehicle. If an obstacle is recognized, the driver is warned optically or acoustically.

For long-range distance measurement with the aid of electromagnetic radiation, it is known to use radar and lidar (light in the near-infrared range). With the use of radar, the distance to foreign objects in a narrow beam of radiation up to 120 meters in front of the vehicle is determined. In addition to the distance, the control device can easily calculate the relative speed of the foreign object in relation to the vehicle.

In order to improve the functionality of the passive safety in the vehicle, it is desirable to evaluate the items of information coming from the above-named distance and acceleration sensors together, in order to intelligently control the activation of the corresponding restraint systems, such as safety belts and air bags, because the degree of activation depends, in addition to the weight of the vehicle passengers to be protected, primarily on the type and severity of the accident. The control device can use this information for the decision concerning a triggering of the restraint means shortly after the impact (preset) or even before the impact (pre-fire).

### SUMMARY OF THE INVENTION

An object of the present invention is to provide a compact, multifunctional sensor element.

According to the present invention, this object is achieved by a sensor element for acquiring the acceleration of a motor vehicle.

Due to the fact that the sensor element includes at least one distance measuring device for measuring the distance to an object situated in the measurement range of the distance measurement device, it is advantageously achieved that the two above-named measurement principles are united in one and the same component, resulting in a high degree of functionality at a low production cost. This includes lower material costs for cabling and housing, as well as reduced manufacturing costs. Consequently, high equipping rates can be achieved even in high-volume market segments (small cars).

The sensor can be used to realize a plurality of different functionalities that can be progressively interlinked by expanding the logic in the control device. In addition to the predictive (look-ahead) functionality, which can be used in a known manner to protect pedestrians and to aid in parking, signals sent to the evaluation electronics system by the two measurement principles can be used to derive information concerning the severity of a collision with a foreign object.

In the case of the use of a radar system as a distance measurement device, distances from other vehicles at long range are detected, thus enabling a relatively early calculation of the time remaining before the collision.

With the use of an ultrasonic sensor as a distance measurement device at close range, it is also possible to calculate the relative speed between the vehicle and a foreign object based on the signals supplied to the evaluation electronics system, making it possible to distinguish various accident scenarios.

On the basis of the received signals, the control device can be parameterized at an early point in time. In particular, by comparing the relative speed between the vehicle and the detected foreign object with the inherent speed of the vehicle, if warranted it can be ruled out that the foreign object is a pedestrian.

It can also be determined whether an object has actually approached the vehicle or whether the vehicle has experienced the measured acceleration solely as a result of vibrations.

In a preferred construction of the present invention, it is provided that the sensor element senses in a biaxial manner. In this way, it is achieved that the above-cited classification of a collision can also be carried out for a side collision or an oblique collision. Given triaxial sensing, an acceleration in the vertical direction can also be detected, which is relevant when traveling on uneven terrain (off-road recognition).

In particular, it is preferred that the distance measurement device be attached parallel to the longitudinal axis of the vehicle, in the forward direction relative to the seismic mass. This makes it possible for the distance measurement device to be oriented towards the front, and not hindered in its field of vision.

### BRIEF DESCRIPTION OF THE DRAWING

The FIGURE shows a schematic top view of a multifunctional upfront sensor.

### DETAILED DESCRIPTION

The FIGURE shows a sensor element, designated 100 as a whole. An acceleration measurement device 10 is housed in a common sensor housing 12 together with a distance measurement device 16. Distance measurement device 16 is here attached before acceleration measurement device 10, relative to the direction of travel. Distance measurement device 16 preferably terminates flush with the front surface of vehicle 18. Signals from acceleration measurement device 10 and from distance measurement device 16 are supplied (shown only schematically here) to an evaluation electronics unit 14 that interprets these signals logically. Due to the fact that acceleration measurement device 10 is positioned very far forward on the vehicle body, in the case of a collision this device must tolerate very high accelerations, which can be achieved by a higher setting of the measurement range than would be the case for acceleration measurement devices situated further back. Likewise, sensor housing 12 must be robust enough to ensure the functioning of acceleration measurement device 10 during the first 50 ms after a collision. The same holds for the transmission of data to the control device.

For the realization of the described functionality of the upfront sensor, it is sufficient to equip the vehicle with one to two sensors according to the present invention.

1-8. (canceled)

9. A sensor element for acquiring an acceleration of a motor vehicle comprising:
a sensor housing;
a seismic mass suspended elastically inside the sensor housing;
an evaluation electronics system for recognizing an acceleration-caused deflection of the seismic mass; and
at least one distance measurement device for measuring a distance to an object situated in a measurement area of the distance measurement device.

10. The sensor element according to claim 9, wherein the sensor element senses biaxially.

11. The sensor element according to claim 9, wherein the sensor element senses triaxially.

12. The sensor element according to claim 9, wherein the distance measurement device is attached in a forward direction relative to the seismic mass, parallel to a vehicle longitudinal axis.

13. The sensor element according to claim 9, wherein the distance measurement device terminates flush with a front surface of the vehicle.

14. The sensor element according to claim 9 , wherein the distance measurement device is an ultrasonic sensor.

15. The sensor element according to claim 9, wherein the distance measurement device is a radar device.

16. The sensor element according to claim 9, wherein the distance measurement device is a lidar device.
